(19) United States
(12) Patent Application Publication
(10) Pub. No.: US 2018/0274965 A1
(43) Pub. Date: Sep. 27, 2018

(54) Equalizing reservoir with fill level sensor

(71) Applicant: GM GLOBAL TECHNOLOGY OPERATIONS LLC, Detroit, MI (US)

(72) Inventors: Richard Kerkewitz, Gross-Gerau (DE); Klaus Xaver Hofmann, Oestrich-Winkel (DE)

(73) Assignee: GM GLOBAL TECHNOLOGY OPERATIONS LLC, Detroit, MI (US)

(21) Appl. No.: 15/935,823

(22) Filed: Mar. 26, 2018

(30) Foreign Application Priority Data
Mar. 24, 2017 (DE) 102017002856.7

(51) Int. Cl. G01F 23/26; F01P 11/18; F01P 11/02

(52) U.S. Cl. CPC G01F 23/268; F01P 11/028; F01P 11/0209; F01P 11/18

(57) ABSTRACT

The present development relates to a closure cap for an equalizing reservoir of a motor vehicle cooling arrangement. The closure cap includes a cap body and a fill level sensor arranged on the cap body. The fill level sensor enables the fill level of the coolant inside the equalizing reservoir to be measured. The cap body may be disposed removably on the equalizing reservoir and typically closes off a filling opening of the equalizing reservoir. The configuration of the fill level sensor on the cap is extremely versatile, and can be used for a very wide range of equalizing reservoirs, which in principle can be closed with the same cover.

### CROSS-REFERENCE TO RELATED APPLICATION

This application claims priority to German Patent Application No. 102017002856.7, filed Mar. 24, 2017, which is incorporated herein by reference in its entirety.

### TECHNICAL FIELD

The present disclosure pertains to an equalizing reservoir with a fill level sensor for a coolant circuit in a motor vehicle.

### BACKGROUND

Standard motor vehicles with a drive system which generates waste heat include a motor vehicle cooling system with a coolant circuit via which the drive system, such as an internal combustion engine, can be thermally coupled to a heat exchanger, such as a water cooler. A coolant such as coolant water with antifreeze additives circulates in the coolant circuit.

In order to fill the coolant circuit with the coolant initially and to separate and precipitate gas bubbles which are unavoidably present therein, standard coolant circuits include an equalizing reservoir. Such a reservoir typically has an infeed and an outflow for the coolant. To ensure that the motor vehicle cooling system functions properly, steps must be taken to guarantee that there are no leaks in the coolant circuit and that there is always sufficient coolant circulating in the coolant circuit.

### SUMMARY

In accordance with the present disclosure, an improved equalizing reservoir is provided together with the closure for a motor vehicle cooling arrangement. Any leak in the coolant circuit should thus be detected or detectable as directly and early as possible, to prevent the motor vehicle cooling arrangement from possibly overheating, or also to counteract other consequences arising therefrom as soon as possible. The improvement is suitable for implementation in as many situations as possible for variously configured or dimensioned equalizing reservoirs, and is capable of immediate application. It is also possible to integrate the improved equalizing reservoir in existing concepts as inexpensively as possible.

A closure cap is provided for an equalizing reservoir of a motor vehicle cooling assembly. The closure cap has a cap body and a fill level sensor which is disposed on the cap body. The fill level sensor enables the fill level of the coolant inside the equalizing reservoir to be measured. The cap body may be disposed removably on the equalizing reservoir. It typically closes off a filling opening of the equalizing reservoir. The fill level sensor is disposed only on the closure cap, and thus on the cap body thereof. Consequently, the fill level sensor is extremely versatile, and can be used for a very wide range of equalizing reservoirs, which in principle can be closed with the same cover.

Different motor vehicles with equalizing reservoirs of correspondingly different sizes or shapes can be closed with the same type of closure cap. If the fill level sensor is attached to this closure cap, a fill level measurement may be provided for any equalizing reservoir. No modifications have to be made to the reservoir itself. To this extent, the implementation of the fill level sensor in or on the closure cap serves as a particularly inexpensive, universally usable fill level measurement system.

According to a further development, the fill level sensor includes an elongated first sensor element, which protrudes into an interior volume of the equalizing reservoir when the closure cap is arranged on the equalizing reservoir. The closure cap may typically be disposed on a top side of the equalizing reservoir. There, it closes a filling port. When the fill level sensor with the elongated first sensor element protrudes into the inside or the interior volume of the equalizing reservoir, it is able to pass below the surface of the coolant in the reservoir. This immersion can be detected immediately by the at least first elongated sensor or probe element. If the fill level should fall below a predefined level, so that a distal end of the elongated first sensor element no longer dips into the coolant, this can be detected immediately with the sensor element.

The lengthwise extension of the first sensor elements is at least as long as or longer than a distance between a predefined fill level of the coolant and the top side of the equalizing reservoir. This ensures that when the fill level of the coolant in the equalizing reservoir is in order, an end section of the first sensor element dips into the coolant when a closure cap is mounted on the reservoir and closes a filling opening.

According to a further variant, the fill level sensor or the fill level probe has a second elongated sensor element or a corresponding probe element. The second sensor element may cooperate with the first sensor element. Or it may also function as a separate, redundant sensor element. The second sensor element may be largely identical to the first sensor element. It may carry out a second measurement of the fill level in addition to that of the first sensor element. The first and second sensor element may each carry out a fill level measurement independently of each other, as it were.

However, according to a further variant it is provided that the first sensor element and the second sensor element cooperate for measuring purposes to determine the fill level of the coolant in the equalizing reservoir.

According to a further variant, the first and the second sensor elements extend parallel to each other. It may further be provided that the first sensor element and the second sensor element have identical lengthwise extensions. The first and second sensor elements may also be disposed on the closure cap in the same manner, so that a distal end of the first sensor element and a distal end of the second sensor element, the ends farthest from the closure cap, are positioned at approximately the same level relative to the lengthwise extensions of the first and the second sensor elements.

According to a further variant, at least one of the first or second elements is an electrical sensor element. Moreover, both sensor elements, that is to say the first and the second sensor elements may be embodied in electrical sensor elements. Even in embodiments in which only a single sensor element—the first sensor element—is provided, the first sensor element may be embodied as an electrical sensor element.

An electrical sensor element is particularly suitable for electrical or electronic evaluation of a measurement value. Accordingly, the electrical sensor element is typically connectible or connected to an electric evaluation unit or controller in a manner that allows the emission of electrical signals and/or the transmission of electrical signals.

Electrical signals which can be generated by a first sensor element and a second sensor element may deliver information regarding the fill level in the interior of the equalizing reservoir when the closure cap is in place. On the basis of an electrical signal which may be produced by at least a first and a second sensor element, it may be determined whether the actual fill level in the interior of the equalizing reservoir is either above a specified lower threshold value.

In addition and as a further development thereof, it may be provided that the amplitude or the frequency of the measurable electrical signal are in direct correlation with the actual fill level inside the equalization reservoir. To this extent, the closure cap may be designed such that the actual fill level in the equalization reservoir can be determined by the fill level sensor and forwarded by the transmission of a signal to an evaluation unit or controller of the motor vehicle, or optionally to a driver information or warning unit.

According to a further variant of the closure cap, at least one of the first and second sensor elements may be equipped with a capacitive measuring electrode. In variants with only one sensor element, it is conceivable that the capacitive measuring electrode performs a capacitance measurement relative to a wall of the equalizing reservoir. The wall of the equalizing reservoir would preferably be designed so as to be electrically conductive for this purpose. The electrical capacitance measurable with the measuring electrode varies depending on the fill level of the liquid present between the reservoir wall and the capacitive measuring electrode.

In designs of the closure cap in which the first sensor element and the second sensor element are each equipped with a capacitive measuring electrode, an electrical capacitance measurement may by performed between the first and the second capacitive measuring electrodes. In such a variant, it is not necessary for a reservoir wall to be electrically conductive. The equalizing reservoir may be designed in the form of a plastic component, for example.

If the first and second sensor elements are each equipped with a capacitive measuring electrode, a quantitative measurement of the fill level may be performed. The dielectric capacity measurable between the capacitive measuring electrodes is a direct indicator of the fill level of the coolant in the interior of the equalizing reservoir.

According to a further variant, at least one of the first and second sensor elements is coated with an electrical insulator. The electrical insulator may be a plastic insulator, for example. The electrical insulator prevents electrically conductive contact between the first and second sensor elements, particularly when both sensor elements are immersed in the coolant.

According to a further variant, the closure cap also has an insert projection from a bottom side of the cap body. The insert is designed so that when the closure cap is positioned on the filling port of the equalizing reservoir the reservoir is closed in fluid-tight manner or sealed. When the closure cap is disposed on the equalizing reservoir, the insert protrudes into the interior of the filling ports and forms a seal against the inner wall of the filling port. A sealing insert of such kind may be used particularly in combination with an overpressure device.

According to a further variant, the cap body has a gasket which is movable towards a top side of the cap body against a restoring force exerted by a spring. The gasket may particularly be embodied as a component of an overpressure device of the closure cap. If the pressure in the interior of the closed equalizing reservoir rises above a permitted maximum level, the gasket may be raised against the spring force and break a sealing seat with the cap body or the insert. Thus, a kind of forced leak position may be created temporarily, so that excess coolant or steam can escape from the interior of the equalizing reservoir in controlled manner. In this way the equalization reservoir may be kept free from damage.

According to a further development, the gasket may have a pass-through opening through which the at least one sensor element passes axially. The pass-through opening may be arranged concentrically in the gasket. The elongated sensor element or an electrical connection may be routed through the pass-through opening via a bushing, for example, and sealed with a sealing compound, for example. It is conceivable that the pass-through opening may be filled with a filling compound or a sealing compound which surrounds the sensor element in sealing manner.

According to a further variant, it is provided that the first and/or the second sensor element is/are arranged on the insert. Since the insert is typically arranged on the bottom side of the cap body, the body may serve primarily to arrange the sensor elements protruding into the interior volume of the equalizing reservoir.

It is further conceivable to arrange the one or more sensor elements on the movable gasket. The advantage of this would be that if the gasket were to shift relative to the cap body due to overpressure the one or more sensor elements would be able to detect a sudden change in the fill level. If the one or more sensor elements together with the gasket shifts relative to the cap body and relative to the equalizing reservoir, the immersion depth of the sensor elements in the coolant changes. This can be detected immediately by the evaluation unit, which is connected in signal-transmitting manner with the sensor elements.

According to a further variant, it is also provided that the closure cap has a connector which is accessible from outside the cap body. The plug is connected in electrically conductive manner to at least one of the first and second sensor elements. The connector is advantageously connected to both, that is to say the first and the second sensor elements. The connector may have a standardized socket or a standardized plug on the outside of the cap body. In this way, the fill level sensor integrated in the closure cap may be connected electrically with an evaluation unit. The connector allows the signal connection between the fill level sensor and an evaluation unit or controller in the motor vehicle to be disconnected temporarily so that any maintenance work can be carried out, so that the equalizing reservoir can be filled with coolant, for example.

According to a further variant, the connector is integrated in the cap body. In this case, the connector stands out from a lateral cap wall or from a top side of the cap body. The connector which is raised at least slightly above the outer contour of the cap body enables particularly intuitive, simple handling for producing an electrically conductive plug connection between the fill level sensor and an evaluation unit or controller of the motor vehicle situated outside the equalizing reservoir.

The electrical connection between one of the first or second sensor elements and the connector arranged on the outside of the cap body is designed such that the length thereof can be altered. One or more connection cables between the at least one sensor element and the connector may be arranged relatively loosely and with a predetermined excess length in the interior of the cap body. In this context, one end of the cable is hard-wired to at least one of the first or second sensor elements, while the opposite end is hard-wired to the connector. An excess length of the cable allows a relative movement of the one or more sensor elements with respect to the cap body.

According to a further aspect, an equalization reservoir of a motor vehicle cooling arrangement is also provided. Such a reservoir has an interior volume designed to hold a coolant. The interior volume of the equalizing reservoir is delimited by a reservoir wall. In other words, the reservoir wall forms the interior volume of the equalizing reservoir. The equalizing reservoir further has a filling port which perforates or penetrates the reservoir wall, and on which a closure cap as described previously is disposed or may be disposed detachably.

The equalization reservoir typically has a reservoir wall made of plastic. The reservoir wall may be constructed as a single part or multiple parts. It may be embodied as a blow-molded or injection molded part. The filling port is typically located on an end section which is uppermost with regard to its subsequent installed position in the motor vehicle or on a top side of the equalizing reservoir. Since the closure cap is equipped with a fill level sensor, when the filling port is closed as prescribed a direct measurement of the fill level of the coolant in the interior volume of the reservoir may be carried out without the need to make any alterations to the reservoir wall for this purpose. The fill level sensor may be integrated in the closure cap for practically any design of equalizing reservoir for a motor vehicle cooling arrangement and represents a direct, functional extension of the equalization reservoir.

According to a further aspect a motor vehicle cooling arrangement is provided which has a heat source, at least one heat exchanger and an equalizing reservoir as described previously. The heat source, the at least one heat exchanger and the equalizing reservoir are connected to each other in fluid-conveying manner via the coolant circuit.

The motor vehicle cooling arrangement may further be equipped with an evaluation unit or a controller, which is or can be connected in signal-transmitting manner to the fill level sensor of the closure cap. The evaluation unit enables permanent or temporary measurement of the fill level inside the equalizing reservoir. If the fill level of the coolant in the equalizing reservoir should fall below a predetermined level, this may be detected by the evaluation unit. Corresponding information may be forwarded immediately to a motor vehicle controller so that appropriate countermeasures may be initiated. For example, the evaluation unit may be designed to produce a corresponding warning signal in a display in the motor vehicle interior.

Finally, according to a further aspect a motor vehicle having a motor vehicle cooling arrangement as described previously and/or an equalizing reservoir as described previously is provided. In this case, the equalizing reservoir is closable or closed with a closure cap as described previously. The fill level sensor integrated in the cap enables real-time measurement of the fill level of the coolant in the interior volume of the equalizing reservoir.

### BRIEF DESCRIPTION OF THE DRAWINGS

The present disclosure will hereinafter be described in conjunction with the following drawing figures, wherein like numerals denote like elements.

FIG. 1 is a side view of a motor vehicle;

FIG. 2 is a schematic representation of a motor vehicle cooling arrangement in the form of a block diagram;

FIG. 3 is a cross-section through an equalizing reservoir;

FIG. 4 is an enlarged representation of the region of the closure cap in FIG. 3; and

FIG. 5 is a perspective representation of the closure cap separated from the equalizing reservoir.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

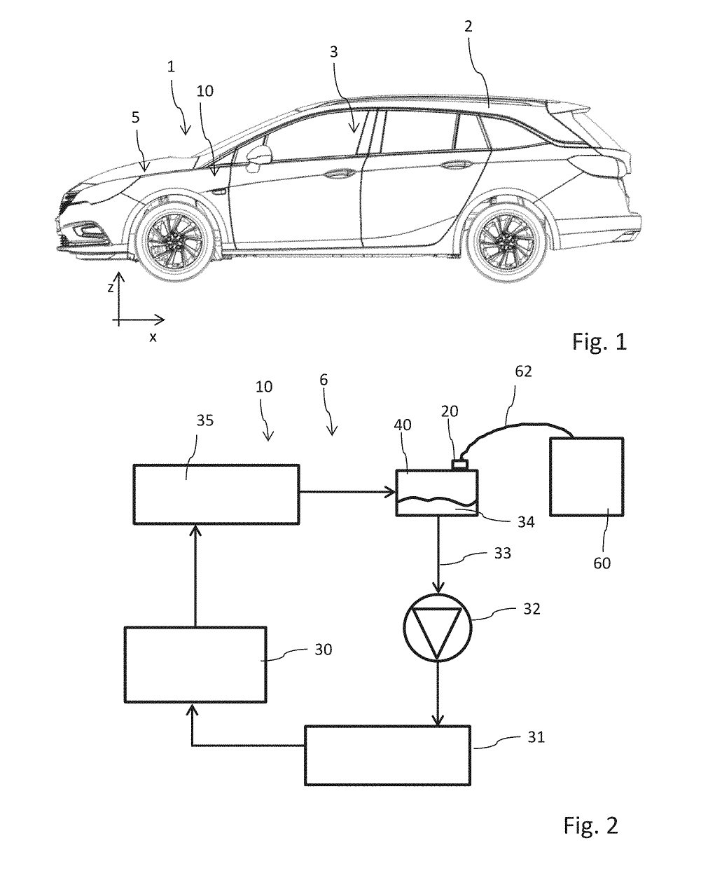

The motor vehicle 1 represented schematically in FIG. 1 includes a self-supporting vehicle body 2 with an interior space 3 which functions as a passenger cabin. An engine compartment 5 in which a heat source 30 with a coolant circuit 6 as represented schematically in FIG. 2 is provided in front of interior space 3. Heat source 30 may particularly be embodied as an internal combustion engine. Besides heat source 30, the coolant circuit 6 represented schematically in FIG. 2 has a heat exchanger 31, a pump 32 and a coolant line 33. This serves to ensure that a coolant 34 is circulated in controlled manner through the closed coolant circuit 6.

Heat exchanger 31 may be embodied as a water cooler, which is typically arranged in a front section of vehicle body 2 and across which an airstream due to the vehicle's movement flows. A further heat exchanger 35 may also be arranged downstream from heat source 30 in the coolant circuit, by which the interior space 3 of motor vehicle 1 may be heated according to needs.

Coolant circuit 6 also includes an equalizing reservoir 40, which is typically disposed upstream of pump 32 in coolant circuit 6. Equalizing reservoir 40 includes a reservoir wall 41 and an opening 42 which is closable with a closure cap 20. Opening 42 is located on a top side of reservoir wall 41. In this region, as is shown particularly in FIG. 4, a filling port 43 is provided which protrudes upwards at least slightly above the top side of reservoir wall 41. The outer side of filling port 43 has a threaded section 44. Threaded section 44 is designed as an outer thread or an inner thread. A coolant 34 may be poured into the interior volume 45 of equalizing reservoir 40 through filling port 43 and the opening 42 formed thereby in the top side of reservoir wall 41.

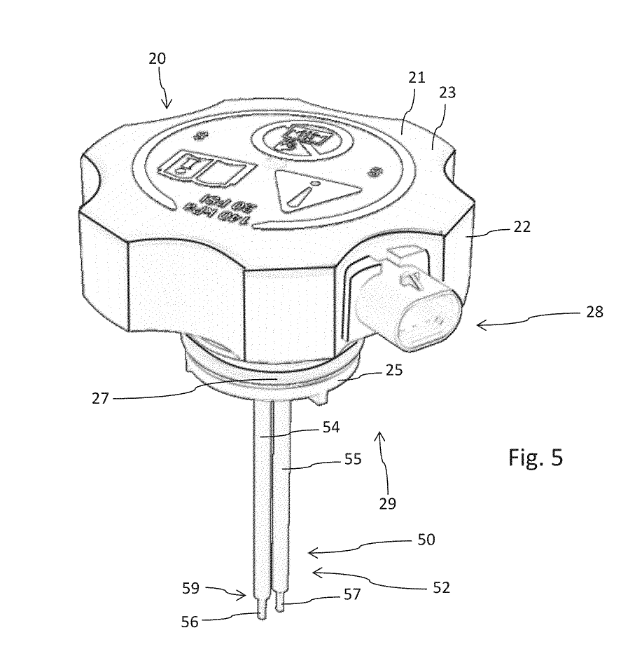

FIG. 4 shows a closed position of closure cap 20 on equalization reservoir 40. Closure cap 20 has a cap body 21 with a lateral cap wall 22. As shown schematically in FIG. 5, lateral cap wall 22 may be furnished with a kind of fluting, by which cap body 21 may be enclosed particularly well, with particularly effective slip protection. A threaded section 24 which cooperates with the outer thread or inner thread and with threaded section 44 of filling port 43 is also provided on an inner side of lateral cap wall 22. Threaded section 24 is embodied as an inner thread. Accordingly, closure cap 20 is embodied as a screw cap.

Closure cap 20 further has an insert 25 which is disposed on a bottom side of cap body 21. Insert 25 is arranged rigidly on cap body 21 and seals filling port 43 of when closure cap 20 is fitted. A gasket 47 is fitted movably on or in the insert. In the basic position shown in FIG. 4. The lower, front face of gasket 47 facing interior volume 45 lies flush against insert 25 in sealing manner. It can be moved into a raised, detached position against the returning force of a spring 58, particularly when an overpressure greater than a permissible threshold value exists in interior volume 45.

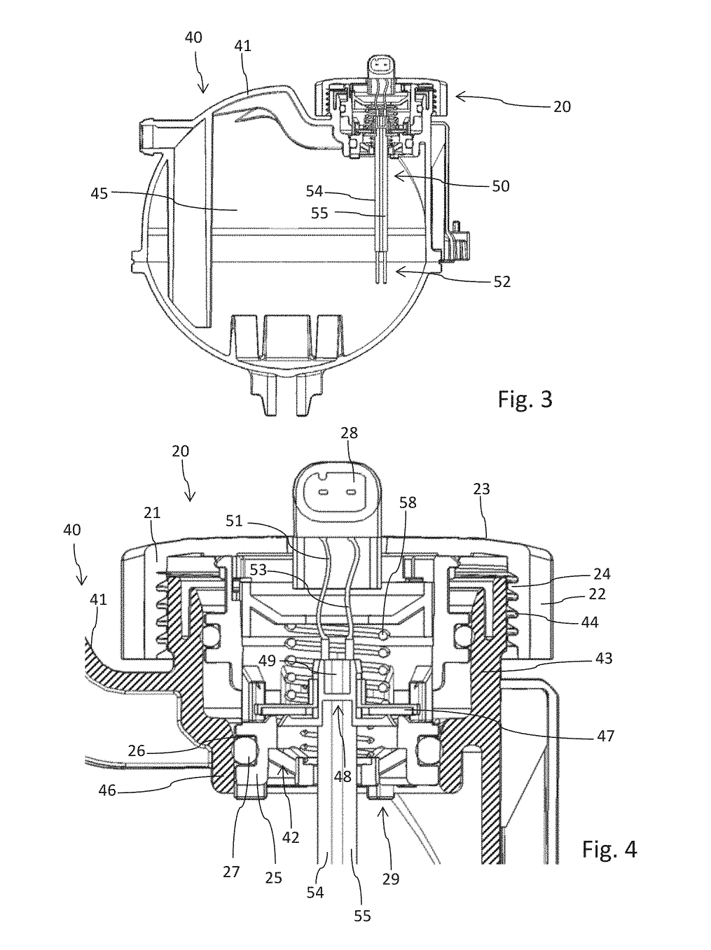

Spring 58 may be compressed against an elastic restoring force in the axial direction, that is to say the vertical direction according to FIG. 3 or FIG. 4, so that gasket 47 in the form of a dished washer may be opened with a seal provided there, thus compensating for the overpressure or under pressure. A top end of spring 58 bears on insert 25. A bottom end of spring 58 bears on gasket 47.

In the released position, the raised counterpart to the basic position, an excess pressure relief may be provided. The liquid and/or gas-phase coolant 34 may be allowed to escape interior volume 45 in controlled manner. In this way both the equalization reservoir 40 and the entire coolant circuit 6 may be kept free from damage. The region above insert 25 and cap body 21 is permeable to gas and/or fluid, allowing them to escape to the ambient atmosphere.

A pass-through opening 48 is provided approximately in the middle of gasket 47, through which sensor elements 54, 55 are routed axially. A separate bushing 49 may be provided to enable sensor elements 54, 55 to pass through gasket 47. Bushing 49 may function as a casing for sensor elements 54, 55 or for corresponding cables 51, 53. The intermediate space between bushing 49, sensor elements 54, 55 or corresponding cables 51, 53 and an intermediate space between bushing 49 and pass-through opening 48 may be packed in sealing manner with a filling compound or a sealing compound. Sensor element 54, 55 and/or cables 51, 53 may be injection molded into bushing 49 and/or into gasket 47.

As represented in FIG. 4, insert 25 has a disc-like or cylindrical shape with a groove 26 which extends in a circle all around the outer wall thereof. A seal 27 is fitted circumferentially in groove 26. In the closed position as shown in FIG. 4, insert 25 engages in sealing manner with a correspondingly designed cylindrical section 46 of reservoir wall 41. Cylindrical section 46 is flared radially in the upward direction. In the basic configuration shown in FIG. 4, insert 25 is mounted supported inside cylindrical section 46 to form a seal.

A fill level sensor 50 is provided on bottom side 29 of cap body 21. Fill level sensor 50 is embodied as measuring probe 52, at least a section of which is immersed in coolant 34 when equalizing reservoir 40 is filled properly with coolant 34. In the present embodiment, fill level sensor 50 is equipped with a first sensor element 54 and a second sensor element 55. The first and second sensor elements 54, 55 extend parallel to each other. Sensor elements 54, 55 have an identical lengthwise extension. They may also be surrounded by an electrically insulating casing 59, or be positioned at a distance from each other without a casing, so that no electrical connection is created between them. Sensor elements 54, 55 are particularly embodied as capacitive measuring electrodes 56, 57 or include measuring electrodes of such kind.

Accordingly, sensor element 54, 55 may consist of corresponding measuring electrodes 56, 57. Or, the entire sensor 50 integrated in closure cap 20 may substantially be formed by sensor elements 54, 55. In this way, a particularly inexpensive, effective sensor arrangement may be created. The electrical signals from the sensor may be evaluated outside of the closure cap, in a region of the motor vehicle which is exposed to less extreme thermal loads.

Regarding installation, sensor elements 54, 55 are arranged on a bottom side of insert 25. In this way, it is ensured that they are immersed in the liquid in equalizing reservoir 40 when closure cap 20 is mounted properly on the reservoir. The capacitive measuring electrodes 56, 57 serve to measure a dielectric constant between the first and the second sensor elements 54, 55. When the fill level of the coolant 34 changes in interior volume 45 of equalization reservoir 40, the dielectric constant measurable between first and second sensor elements 54, 55 changes as well.

Sensor elements 54, 55 are connected to a connector 28 via cables 51, 53, elastic, conductive elements or a sliding contact device. In the illustration of FIG. 4, connector 28 is located on top side 23 of cap body 21. In the alternative variant shown in FIG. 5, connector 28 is located in lateral cap wall 22. In this case, the connector protrudes either from the top side 23 or from the cap wall 22. This renders it particularly easy to take hold of, and it may be connected particularly easily with a correspondingly formed plug. In the present example, connector 28 is embodied as a socket.

FIG. 2 further shows that closure cap 20 is or may be connected to an evaluation unit 60 or controller of motor vehicle 1 via a connection cable 62. Electrical signals which are or may be generated by first and second sensor elements 54, 55 may be transmitted to the evaluation unit 60 via cables 51, 53 and via the connection cable which is attached to closure cap 20. In the evaluation unit, the signals may be evaluated for measurement purposes. Evaluation unit 60 may be embodied as a separate evaluation unit. However, it may also be integrated in a motor vehicle controller or a central automobile control unit or a central controller of motor vehicle cooling assembly 10.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment as contemplated herein. It should be understood that various changes may be made in the function and arrangement of elements described in an exemplary embodiment without departing from the scope of the invention as set forth in the appended claims.

1-15. (canceled)

16. An equalizing reservoir for a motor vehicle cooling system comprising:
a tank having an interior volume in fluid communication with the motor vehicle cooling system and a filling port formed therein;
a cap body releasably mounted on the tank to cover the filling port; and
an electronic fill level sensor extending from the cap body and configured to measure a fluid level in the tank.

17. The equalizing reservoir according to claim 16, wherein the electronic fill level sensor comprises an elongated first sensor element protrudes into the interior volume of the equalizing reservoir when the closure cap is mounted on the equalizing reservoir.

18. The equalizing reservoir according to claim 17, wherein the electronic fill level sensor comprises a second sensor element.

19. The equalizing reservoir according to claim 18, wherein the second sensor elements comprises a second elongated sensor element extending parallel to the first elongated sensor element.

20. The equalizing reservoir according to claim 16, wherein the electronic fill level sensor comprises a first sensor element and a second sensor element, at least one of the first or second sensor elements comprises an electrical sensor element.

21. The equalizing reservoir according to claim 16, wherein the electronic fill level sensor comprises a first sensor element and a second sensor element, at least one of the first or second sensor elements comprises a capacitive measuring electrode.

22. The equalizing reservoir according to claim 16, wherein the electronic fill level sensor comprises a first sensor element and a second sensor element, at least one of the first or second sensor elements having an electrical insulating coating.

23. The equalizing reservoir according to claim 16, further comprising an insert protruding from a bottom side of the cap body for sealing the filling port of the tank with the closure cap arranged on the tank.

24. The equalizing reservoir according to claim 23, wherein the electronic fill level sensor is arranged on the insert.

25. The equalizing reservoir according to claim 16, further comprising a gasket arranged on the cap body, which is movable towards a top side of the cap body against a restoring force generated by a spring.

26. The equalizing reservoir according to claim 25, wherein the electronic fill level sensor is arranged on the gasket.

27. The equalizing reservoir according to claim 16, further comprising a connector extending from an outer surface of the cap body and connected in electrically conductive manner to the electronic fill level sensor.

28. The equalizing reservoir according claim 27, wherein the connector is formed on the cap body and raised above a cap wall of the cap body.

29. An equalizing reservoir for a motor vehicle cooling system comprising:
a tank having an interior volume in fluid communication with the motor vehicle cooling system and a filling port formed therein;
a cap body releasably mounted on the tank to cover the filling port;
an electronic fill level sensor including an elongated first sensor element and an elongated second sensor element, wherein the electronic fill sensor extends from the cap body and is configured to measure a fluid level in the tank; and
a connector extending from an outer surface of the cap body and connected in electrically conductive manner to the electronic fill level sensor.

30. A motor vehicle cooling system comprising:
a heat source;
a heat exchanger thermally coupled to the heat source; and
an equalizing reservoir fluidically connected to the heat exchanger via a coolant circuit, the equalizing reservoir including:
a tank having an interior volume in fluid communication with coolant circuit and a filling port formed therein;
a cap body releasably mounted on the tank to cover the filling port; and
an electronic fill level sensor extending from the cap body and configured to measure a fluid level in the tank.

31. The motor vehicle cooling system according to claim 29, wherein the electronic fill level sensor comprises a first sensor element and a second sensor element, at least one of the first or second sensor elements comprises an electrical sensor element.
